(19) United States
(12) Patent Application Publication
(10) Pub. No.: US 2011/0057115 A1
(43) Pub. Date: Mar. 10, 2011

(54) APPARATUS FOR STERILISING CONTAINER CLOSURES

(75) Inventors: Pietro Ferraguti, Parma (IT); Paolo Pagliarini, Parma (IT)

(73) Assignee: GEA PROCOMAC S.P.A., 43038 Sala Baganza (Parma) (IT)

(21) Appl. No.: 12/991,141

(22) PCT Filed: May 16, 2008
(86) PCT No.: PCT/IT2008/000327

§ 371 Date: Nov. 5, 2010

(51) Int. Cl. G01N 23/00

(52) U.S. Cl. 250/455.11; 250/492.1

(57) ABSTRACT

Device (1) for feeding container closures, comprising guiding means (2) for conveying the closures (100) to a treatment station associable with said device. The device (1) comprises spacer means (5, 105) to deliver the closures to the treatment station at evenly spaced time intervals, said spacer means being operatively associated with said guiding means (2) and positioned upstream from said treatment station. Apparatus for sterilising container closures equipped with a sterilisation station and comprising such a device (1) for feeding container closures to said sterilisation station.

### TECHNICAL FIELD AND BACKGROUND ART

The present invention relates to the technical sector of container treatment, especially for the bottling industry.

In particular, the present invention relates to a device for feeding container closures.

As is generally known, in the food industry, and in particular in the sector of aseptic filling of containers with beverages and in the sector of aseptic food packaging, there exists a need to sterilise the containers both internally and externally before they are filled.

Sterilisation is generally achieved using chemical agents, e.g. hydrogen peroxide or peracetic acid, which can be used on surfaces of every type, such as paper, plastic, metal or organic materials.

To ensure that filling takes place in aseptic conditions it is necessary to sterilise not only the containers but also their closures, for example caps or stoppers, which serve to seal the containers at the end of the filling process.

According to the known art, the sterilisation of closures, be they caps or stoppers, takes place by means of sources of ionising radiation, for example radioactive gamma or beta ray sources, or by means of chemical agents.

Ionising radiation is radiation comprised of particles with high kinetic energy able to remove electrons from atoms, thereby achieving two important effects:
each interaction between a particle and an atom generates an ion (radical), with consequent freeing of an electron;
the freed electrons are in turn capable of generating additional ions.

With particular reference to sterilisation by means of ionising radiation sources, the use of electron beam emitters, commonly referred to as electron “cannons”, is generally known.

The electron beams are focused on the object to be sterilised in such a manner that the electrons can act directly on pathogenic agents, e.g. viruses, funguses or bacteria, in order to damage the DNA thereof and deactivate the protein and enzymes necessary to their survival.

Sterilisation by ionising sources has the important advantage of reducing the operating costs of filling/bottling plants, since it reduces the consumption of chemical agents, water and sterilising substances. Furthermore, the use of ionising radiation sources permits the construction of environmentally sustainable plants, as it solves the problem of chemical residue disposal and reduces the production of toxic waste.

With particular reference to the sterilization of caps and stoppers, apparatus equipped with a magazine for containing caps and stoppers, connected to a chute for feeding the latter to a sterilisation zone, where they are submitted to ionising radiation of the type described above, are generally known within the bottling industry.

In particular, the chute is made up of a channel having a vertical section and an inclined section, inside which the caps or stoppers are arranged in single file and slide by gravity, passing through an operating zone where they are sterilised. Subsequently, the closures continue sliding until reaching a collection station or a station for further treatment.

Apparatus of this type have a major drawback in that they do not guarantee complete, reliable sterilisation.

In fact, one technical problem that is particularly felt and yet to be resolved arises from the formation of shadow zones at the points of contact between the surfaces of two adjacent closures arranged in single file on the feed chute.

In these shadow zones, caused by contact between two adjacent closures, the ionising radiation is not able to perform its effect. Consequently, any pathogenic agents present in said shadow zones will not be eliminated, thus compromising the sterility of the closures, whether they be caps or stoppers.

### DISCLOSURE OF THE INVENTION

The object of the present invention is to solve the above-mentioned technical problem by making available a device for feeding container closures which is able to prevent the formation of shadow zones between closures in order to allow complete treatment thereof, for example by sterilisation.

Another object of the present invention is to propose a device for feeding container closures that is both simple and reliable.

A further object of the present invention is to devise a device for feeding container closures that can be used for generic closure handling systems and not necessarily in sterilisation apparatus.

Said objects are achieved in full by means of the device for feeding container closures to which the present invention relates, and which is characterised by the elements contained in the claims below.

### BRIEF DESCRIPTION OF THE DRAWINGS

These and other objects will become more apparent from the following description of a preferred embodiment, illustrated solely by way of a non-restrictive example in the appended drawings, in which:

FIG. 1 illustrates an overall layout of a device for feeding container closures according to the invention;

FIG. 2 illustrates an enlarged view from above of the device shown in FIG. 1;

FIG. 3 illustrates an enlarged view from above of a construction detail of the device shown in the previous figures;

FIG. 4 illustrates an axonometric view of the device shown in the previous figures;

FIG. 5 illustrates an axonometric view of a construction detail of one portion of the device positioned in an operating zone where the caps are treated;

FIG. 6 illustrates an axonometric view of the device shown in FIG. 1, associated with a treatment system.

### BEST MODE FOR CARRYING OUT THE INVENTION

With reference to the figures, a device for feeding container closures to a sterilisation apparatus is globally indicated with the number 1.

The device 1 comprises guiding means 2 having an entrance 3 for the closures, typically caps and stoppers, communicating with a loader or magazine (non illustrated) for storing and feeding the closures to be treated.

The device 1 is associable with a closure treatment station 4, which preferably consists in a sterilisation apparatus.

The device 1 comprises spacer means to feed the closures to the treatment station 4 one at a time at evenly spaced time intervals. In particular, said spacer means are operatively associated with the guiding means 2 and positioned upstream from said treatment station 4.

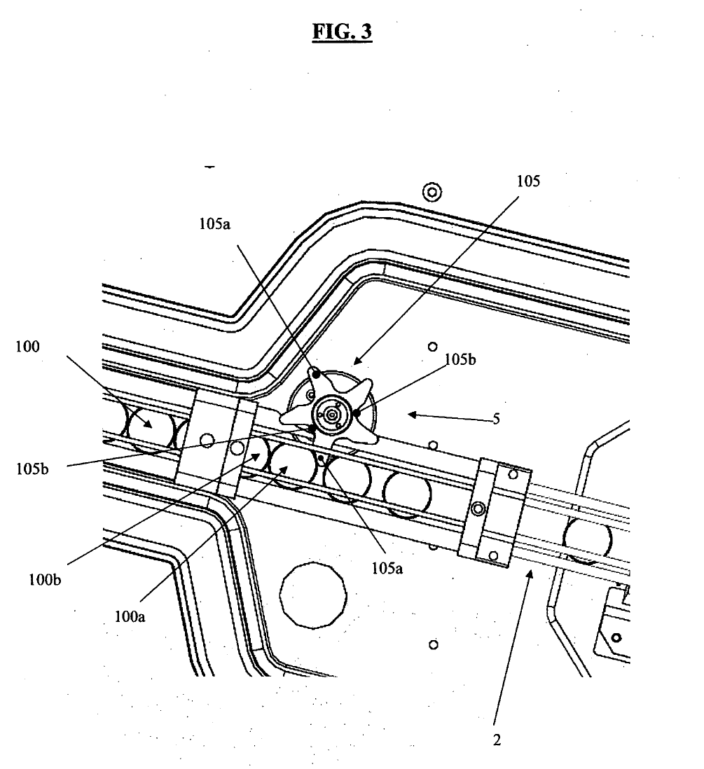

With particular reference to FIG. 3, the spacer means comprise a separator element 5 which is operatively active on a queue of closures 100 to permit the leading closure in the queue 100a to be fed to the treatment station and simultaneously block the remaining closures. More precisely, the separator element can move alternatively between a position for blocking the queue of closures and a position permitting forward movement thereof with simultaneous delivery of the leading closure in the queue 100a to the treatment station.

Following the delivery of the leading closure in the queue 100a, the closure immediately behind it 100b will become the new leading closure in the queue destined to be fed to the treatment station.

With particular reference to FIG. 3, the separator element preferably comprises a star wheel 105 having a plurality of projections 105a with a plurality of recesses 105b suitable for receiving the closures. Preferably, the recesses are shaped to match the closures.

The star wheel rotates in such a manner that each recess 105b will intercept a leading closure in the queue 100a so as to deliver it to the treatment station, while a projection 105a will simultaneously intercept the queue of the remaining closures to prevent them from moving forward.

The star wheel is preferably driven by a brushless-type electric motor, though the use of driving means of a mechanical type, for example by means of gears, is not ruled out.

According to an embodiment not illustrated, said spacer means may comprise a pair of partitions which move simultaneously and alternatively between a position such as to block the queue of closures and a position for feeding the leading closure in the queue. Precisely, said partitions may be aligned at a prefixed distance from each other along the queue of closures and move in an alternating fashion, so that when the partition situated upstream (with reference to the treatment station and along the queue of caps) blocks the queue of closures, the downstream partition will enable the leading closure in the queue to be fed by letting it slide along the guiding means, which will be suitably inclined toward the treatment station.

Subsequently, the upstream partition will be moved out of the blocking position and the downstream partition will simultaneously be positioned in such a way as to obstruct feeding of the leading closure in the queue. In this manner, the queue of closures will descend along the guiding means (due to the inclination thereof) so that the leading closure in the queue comes to rest against the downstream partition and block the entire queue.

Thereafter, the upstream partition will move so as to intercept and block the queue of closures upstream from the leading closure in the queue and at the same time the downstream partition will move to release the leading closure in the queue, allowing it to slide along the guiding means toward the treatment station.

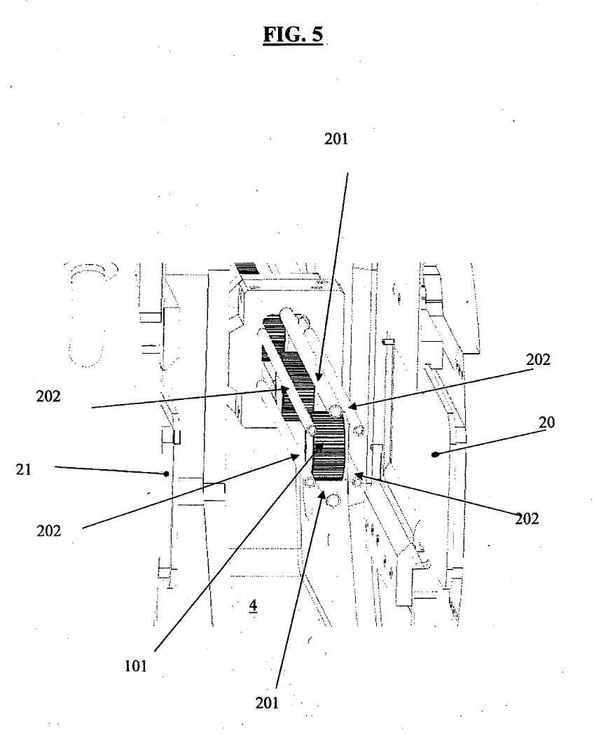

With particular reference to FIG. 5, the guiding means preferably comprise a plurality of guides inclined relative to the horizontal direction, so as to permit the closures to slide by gravity. In particular, there is a first set of guides 201 positioned opposite each other and operatively active on said closures and a second set of guides 202 cooperating with said first guides 201 and operatively active on the closures to keep them in an upright position. In this manner, the lateral edge surface 101 of the closures will rest upon one of said first guides, enabling the closures themselves to roll by gravity.

The device further comprises an outer casing suitable for housing the guiding means, which in the example illustrated are made up of said plurality of guides, and suitable for containing the spacer means, which in the example illustrated consist in the star wheel 105.

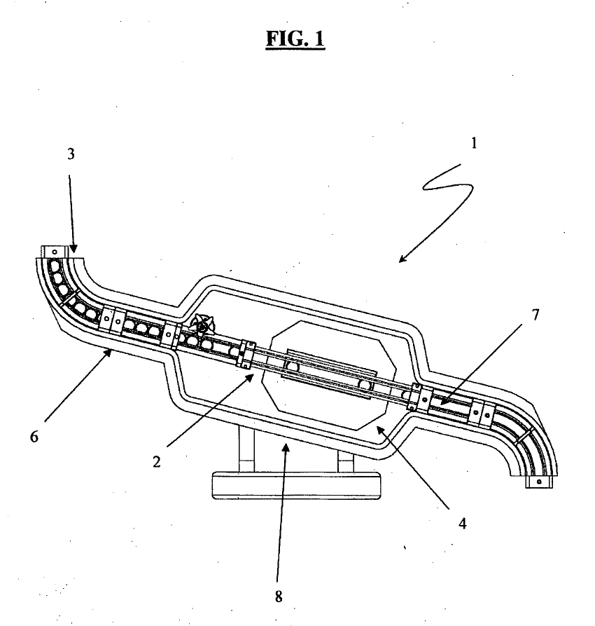

With particular reference to FIG. 1, said outer casing comprises an input channel 6, an output channel 7 and a central body 8, which houses the star wheel 105 and a section of said guiding means.

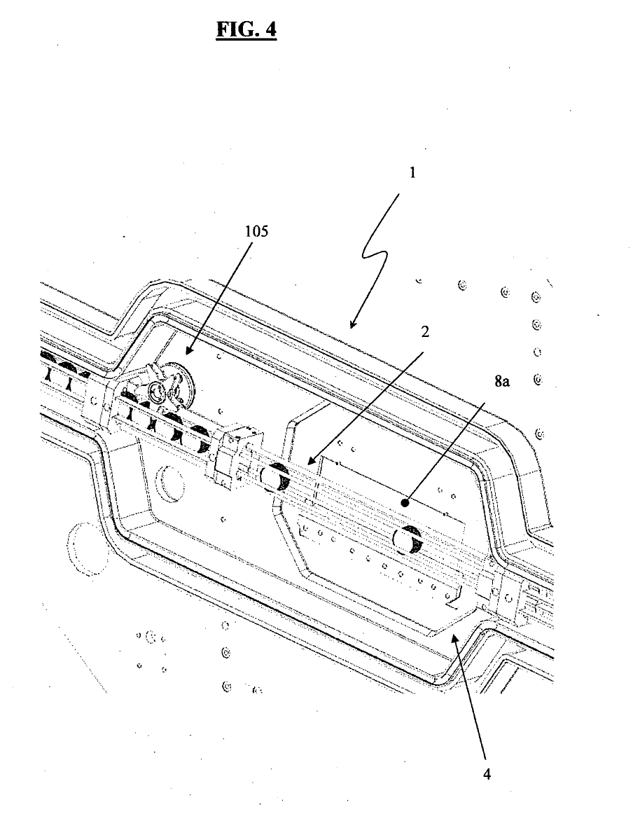

With particular reference to FIG. 4, the central body 8 has a service window 8a positioned in the location of said sterilisation station to enable treatment of the closures that travel along the section of guides housed inside the central body.

In the preferred embodiment, the central body 8 is substantially axially symmetric and has a pair of windows positioned opposite each other, so that the closures conveyed along the guides can be treated from both sides.

The star wheel 105 is preferably positioned between the entrance 3 of said guiding means, typically communicating with a loader or magazine (not illustrated) for storing and feeding the closures to be treated and said treatment station 4.

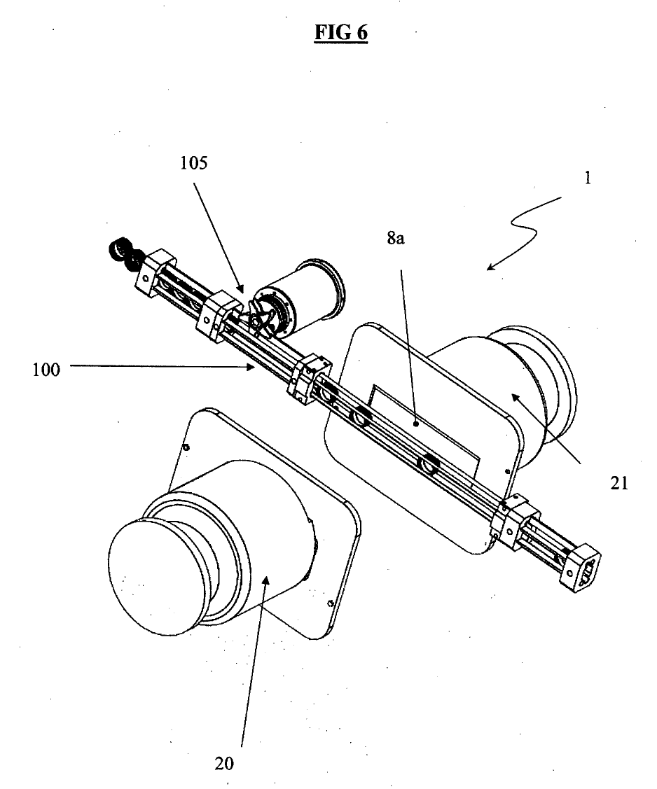

In the preferred embodiment illustrated in FIGS. 5 and 6, the sterilisation station may comprise one or more sources of ionising radiation, for example emitters of electron beams or gamma or beta rays.

If more than one ionising radiation source is used, two electronic beam emitters 20, 21 are preferably present, positioned opposite each other, with the closures to be sterilised passing between them. In such a case, with particular reference to FIGS. 5 and 6, the guiding means are interposed between said pair of emitters 20, 21, which irradiate the closures through the windows 8 (only one of which is visible in the drawings) present on the central body 8 of the outer casing.

The invention works as follows.

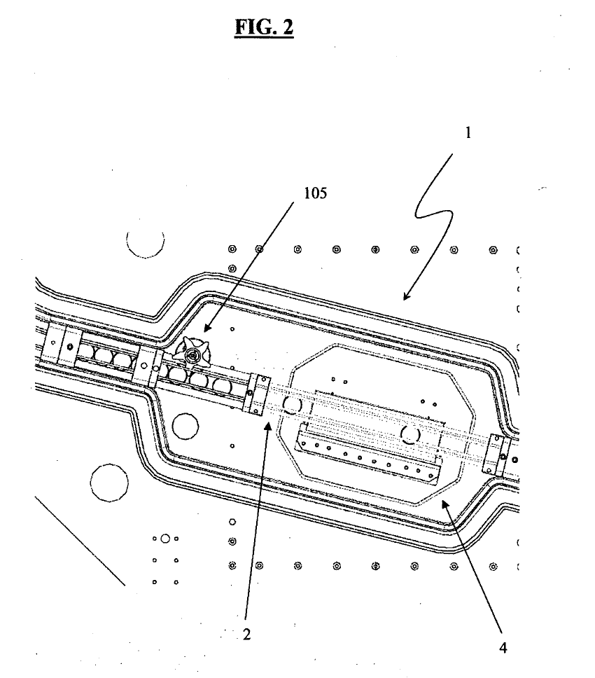

The closures picked up by the storage magazine or loader slide along the guides seated in the input channel 6, forming a single queue that abuts against the star wheel 105 (see in particular FIG. 2).

Precisely, the star wheel 105 is held in a blocking position, such that the leading closure in the queue 100a can come to rest against one of said projections 105a and be introduced at least partially inside a recess 105b of the star wheel, thus stopping the forward movement of the remaining closures and forming a queue that extends back along the input channel.

Subsequently, the star wheel 105 is made to rotate in such a manner as to convey forward the leading closure in the queue 100a and impose upon the latter an initial velocity, which is at least a function of the torque applied to the star wheel and the angular velocity thereof. By virtue of the initial velocity imposed by the star wheel, the leading closure in the queue moves toward the treatment station; in particular, the inclination of the guides relative to the horizontal direction determines an acceleration in the motion of the closures such as to at least offset the friction along the guides themselves and possibly increase the final velocity of the closures.

During rotation of the star wheel, as the leading closure in the queue 100a is introduced inside a recess 105b and consequently conveyed in the direction of the treatment station, a projection 105a simultaneously intercepts the queue of remaining closures and interposes itself between the leading closure in the queue 100a, in the process of being conveyed, and the closure 100b immediately behind it, which is destined to become the new leader of the queue.

After delivering the leading closure in the queue 100a, the star wheel stops rotating so that the new leading closure in the queue will come up against one of said projections 105a and be introduced at least partially inside the recess 105b, thereby stopping the forward movement of the remaining closures.

The invention achieves important advantages.

First of all, a device according to the invention is capable of preventing the formation of shadow zones between closures, thus permitting a complete treatment thereof, for example by sterilisation. Precisely, by controlling the speed of rotation of the star wheel it is possible to introduce a minimum distance between closures, causing them to be delivered at evenly spaced time intervals. In particular, this minimum distance may increase as a result of the gravity acceleration component acting in the direction of the guides, due to the inclination of the guides themselves.

Secondly, such a device makes it possible to establish with precision the closure treatment time, which will be determined by the initial velocity imposed upon the closures by the star wheel and by the frequency at which the star wheel itself feeds closures to the treatment station.

Advantageously, a device according to the invention is capable of regulating the initial velocity at which the closures are delivered to the treatment station on the basis of plant productivity, i.e. on the basis of the number of bottles output per hour. Furthermore, by choosing a suitable inclination of the guides and a suitable distance between the star wheel and service window it is possible to render the closure treatment time independent, within certain limits, from the rotation speed of the star wheel, said speed being preferably correlated with plant productivity.

1. Device (1) for feeding container closures, comprising guiding means (2) for conveying the closures (100) to a treatment station associable with said device, characterised in that it comprises spacer means (5, 105) to deliver the closures to the treatment station at spaced time intervals, said spacer means being operatively associated with said guiding means (2) and positioned upstream from said treatment station.

2. Device according to claim 1, wherein said spacer means comprise a separator element (5, 105) operatively active on a queue of closures to permit delivery of the leading closure in the queue (100a) to the treatment station and simultaneously block the remaining closures, said separator element being able to move alternatively between a position for blocking the queue and a position permitting forward movement thereof, with simultaneous delivery of the leading closure in the queue to the treatment station.

3. Device according to claim 2, wherein said separator element comprises a star wheel (105) having a plurality of projections (105a) alternating with a plurality of recesses (105b) suitable for receiving the closures, said star wheel rotating in such a manner that each recess will intercept a leading closure in the queue (100a) so as to deliver it to the treatment station and a projection will simultaneously intercept the queue of the remaining closures to block the forward movement thereof.

4. Device according to any of the previous claims, wherein said guiding means (2) comprise first guides (201) positioned opposite each other and operatively active on said closures (100).

5. Device according to claim 4, wherein said guides have an inclination relative to the horizontal direction such that the closures can slide by gravity along the guides themselves.

6. Device according to claim 5, wherein said guiding means further comprise second guides (202) cooperating with said first guides (201) and operatively active on the closures to maintain them in an upright position, so that the lateral edge surface (101) of the closures rests upon one of said first guides, thus enabling the closures themselves to roll by gravity.

7. Device according to any of the previous claims, further comprising an outer casing suitable for housing said guiding means (2).

8. Device according to claim 7, wherein said outer casing comprises an input channel (6), an output channel (7) and a central body (8), said central body housing said separator means and at least a portion of said guiding means.

9. Device according to claim 8, wherein said central body (8) has at least one service window (8a) positioned in the location of said sterilisation station to permit treatment of the closures travelling along the guiding means (2) housed inside the central body (8).

10. Device according to any of the previous claims, wherein said guiding means (2) are positioned between an entrance (3) of said guiding means and said treatment station.

11. Apparatus for sterilising container closures, comprising a sterilisation station, characterised in that it comprises a device (1) according to any of the previous claims for feeding container closures to said sterilisation station.

12. Apparatus according to claim 11, wherein said sterilisation station comprises at least one source of ionising radiation.

13. Apparatus according to claim 12, wherein said source of ionising radiation comprises an electron beam emitter.

14. Apparatus according to claim 13, comprising a pair of emitters (20, 21) positioned opposite each other, said guiding means of the closure feeding device being interposed between said emitters in such a manner that the closures are irradiated from both sides.

15. Apparatus according to claim 12, wherein said source of ionising radiation comprises a gamma or beta ray emitter.
